(19) United States
(12) Patent Application Publication
(10) Pub. No.: US 2013/0151085 A1
(43) Pub. Date: Jun. 13, 2013

(54) MOTOR VEHICLE, AND METHOD OF OPERATING A MOTOR VEHICLE

(71) Applicant: Audi AG, Ingolstadt (DE)

(72) Inventors: Franz Roth, Altmannstein (DE); Johann Stoll, Karlskron (DE); Verena Horz, Ingolstadt (DE)

(73) Assignee: Audi AG, Ingolstadt (DE)

(21) Appl. No.: 13/707,046

(22) Filed: Dec. 6, 2012

(30) Foreign Application Priority Data
Dec. 7, 2011 (DE) 10 2011 120 500.8

(51) Int. Cl. B60W 30/08; B60W 10/30; B60W 10/18

(52) U.S. Cl. CPC B60W 30/08; B60W 10/18; B60W 10/30
USPC 701/48

(57) ABSTRACT

In a method of operating a motor vehicle, a trigger signal transmitted to at least one protection device for protecting a pedestrian in the event of an impending collision with the motor vehicle causes activation of the protection device to assume a functional position ready for protection. As the trigger signal is transmitted to the protection device, a control device activates a brake device of the motor vehicle to decelerate the motor vehicle.

### CROSS-REFERENCES TO RELATED APPLICATIONS

This application claims the priority of German Patent Application, Serial No. 10 2011 120 500.8, filed Dec. 7, 2011, pursuant to 35 U.S.C. 119(a)-(d), the content of which is incorporated herein by reference in its entirety as if fully set forth herein.

### BACKGROUND OF THE INVENTION

The present invention relates to a motor vehicle, and to a method of operating a motor vehicle.

It would be desirable and advantageous to address prior art shortcomings.

### SUMMARY OF THE INVENTION

According to one aspect of the present invention, a method of operating a motor vehicle includes transmitting a trigger signal to at least one protection device for protecting a pedestrian in the event of an impending collision with the motor vehicle so as to activate the protection device and cause the protection device to assume a functional position ready for protection, and activating a brake device in response to a transmission of the trigger signal.

The present invention resolves prior art problems by initiating an autonomous emergency braking of the motor vehicle when a trigger signal is transmitted to the protection device. The trigger for implementing the autonomous braking action is thus not directly in response to a detection of a pedestrian or other road user in a surrounding area of the motor vehicle but rather in response to the transmission of the trigger signal by which the protection device is rendered effective. The brake device is therefore rendered operational only when the protection device has received the trigger signal and assumes its functional state.

It is to be understood by persons skilled in the art that the term “pedestrian” is used here in a generic sense and covers any road user including but not limited to a bicycle rider or animal. The protection device is thus also intended for protection of these other road users. As a motor vehicle normally does not come to a halt when colliding with a road user as would be the case for example in a collision with another motor vehicle, the added provision of a braking action in response to the deployment of the protection device significantly minimizes a risk of a secondary collision with other road users. This is of advantage in particular when the deployment of the protection device limits the view of the driver or when the protection device has been inadvertently deployed.

By slowing down the motor vehicle through activation of the brake device, the risk of injury of vehicle occupants is reduced when colliding with other road users after hitting a pedestrian or similar obstacle. In addition, a decrease in the travel speed of the motor vehicle is also beneficial for the colliding road user and reduces the risk of injury in view of the deceleration during the collision.

There may also be a situation in which a pedestrian after colliding with a motor vehicle lies in front of the motor vehicle. By triggering a braking maneuver and slowing down the motor vehicle in time before the motor vehicle can run over the pedestrian, the risk of injury is significantly reduced. The initiation of the autonomous emergency braking action in response to the deployment of the protection device provides a superior protection of the pedestrian or other road user as well as of vehicle occupants.

According to another advantageous feature of the present invention, the brake device can be activated to decelerate the motor vehicle over a predefined time interval. This type of autonomous emergency braking is easy to implement in terms of a control mechanism.

According to another advantageous feature of the present invention, the brake device can be activated to slow down the motor vehicle with a predefined negative acceleration. This is also easy to implement in terms of a control mechanism. In addition, by predefining a certain delay, the speed of the motor vehicle can be rapidly decreased substantially and the risk of injury for vehicle occupants can be significantly reduced.

According to another advantageous feature of the present invention, the brake device can be activated to decrease a travel speed by a predefined magnitude or to decelerate the motor vehicle to a predefined travel speed. Advantageously, a reduction in the travel speed may be realized in a range from 15 km/h to 35 km/h so as to minimize the severity of the accident in the event of a collision with a road user. As the motor vehicle is decelerated to the predefined travel speed, an end speed may be reached of less than 40 km/h, advantageously an end speed of 20 km/h, in order to minimize the severity of the accident.

According to another advantageous feature of the present invention, the brake device can be activated to decelerate the motor vehicle to a point in time in which a driver of the motor vehicle becomes proactive by engaging the brake device or operating a steering wheel. Thus, once the driver regains control of the travel situation by braking and/or maneuver to avoid an obstacle, the autonomous braking action can, optionally, be discontinued.

According to another advantageous feature of the present invention, the brake device can be activated to bring the motor vehicle to a standstill. In this way, the risk of injury to the pedestrian and/or other road users affected by a possible secondary collision can be significantly reduced. A deceleration of the motor vehicle to a standstill may however increase the danger of a rear-end collision. Therefore, according to another advantageous feature of the present invention, this type of braking action of the motor vehicle may be combined with a sensor which is rendered operational when an object behind the motor vehicle in travel direction is detected and transmits a signal to the control unit. In this way, a deceleration to a standstill can be made dependent on whether the space behind the motor vehicle is clear so that the risk of a rear-end collision is substantially reduced.

According to another advantageous feature of the present invention, a pressure of a pressure fluid of the brake device can be increased when at least one sensor detects an object in a trajectory of the motor vehicle. A preconditioning of the brake device in this way enables the brake device to react rapidly in the event the motor vehicle actually collides with a detected object so that the protection device is deployed and consequently the autonomous emergency brake is activated.

According to another advantageous feature of the present invention, the at least one protection device can be an outside airbag, with the trigger signal being transmitted to a controller of the outside airbag of the motor vehicle. Such an outside airbag or window air bag, when deployed, covers in particular solid regions of the vehicle front which cannot or only to a very limited extent configured flexibly. The provision of an outside airbag enables at least a partial coverage of the front window. Such an airbag provides good protection for pedestrians or other road users that are not protected by a vehicle.

According to another advantageous feature of the present invention, the at least one protection device can be complemented by a liftable engine hood of the motor vehicle.

According to another aspect of the present invention, a motor vehicle includes at least one protection device for protecting a pedestrian in the event of an impending collision with the motor vehicle, the at least one protection device being constructed to assume a functional position ready for protection when activated in response to a trigger signal, a brake device, and a control device constructed to operate the brake device in response to a transmission of the trigger signal to the at least one protection device.

### BRIEF DESCRIPTION OF THE DRAWING

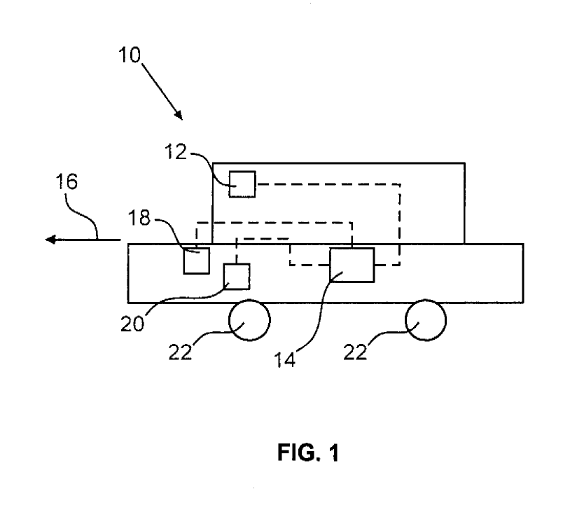

Other features and advantages of the present invention will be more readily apparent upon reading the following description of currently preferred exemplified embodiments of the invention with reference to the accompanying drawing, in which the sole FIG. 1 is a schematic illustration of a motor vehicle having incorporated therein a road user protection system according to the present invention.

### DETAILED DESCRIPTION OF PREFERRED EMBODIMENTS

The depicted embodiment is to be understood as illustrative of the invention and not as limiting in any way. It should also be understood that the figure is not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

Turning now to the drawing, and in particular to FIG. 1, there is shown a schematic illustration of a motor vehicle, generally designated by reference numeral 10 and having incorporated therein a road user protection system according to the present invention. The motor vehicle 10 includes by way of example a window airbag which when deployed causes a control device to autonomously activate an operational brake of the motor vehicle 10 and thereby implement an emergency braking action.

The motor vehicle 10 includes at least one sensor 12 which generates a signal for transmission to a control device 14. The sensor 12 may be configured for detecting vehicle-based parameters and involve, for example, an accelerator sensor or pressure sensor, for detecting an imminent collision or impact. The sensor 12 may also be configured to ascertain an intrusion of an obstacle into the motor vehicle 10 and to transmit a respective signal to the control device 14.

In addition or as an alternative, the sensor 12 may also be configured as a forward-looking device which processes images to generate a signal indicating a warning of an imminent collision. Other examples of a sensor 12 may include those using radar or infrared radiation to detect an obstacle ahead of the motor vehicle 10. Arrow 16 designates in FIG. 1 a travel direction of the motor vehicle.

When the control device 14 determines as a result of analyzing the signals of the at least one sensor 12 that an impact of the motor vehicle 10 with an unprotected road user such as a pedestrian or bicycle rider is imminent, the control device 14 causes a deployment of a protection device, e.g. a window airbag 18, which then covers solid regions of the vehicle front and at least part of the front window of the motor vehicle 10. As a result, the road user is protected against injury in the event of a collision with the engine hood and/or the front window of the motor vehicle 10.

To further improve the protection of a road user in the event of a collision, the control device 14 is further operably connected with a service brake 20 to act on the wheels 22 of the motor vehicle 10. The control device 14 sends an activation signal to the service brake 20 when the protection device 18 is rendered operational through transmission of a trigger signal from the control device 14. Thus, an autonomous emergency braking action is initiated by the control device 14 through operation of the service brake 20 at the same time the window airbag 18 is deployed. As a result, the travel speed of the motor vehicle 10 is significantly decreased. The combination of deployment of the protection device 18 and engagement of an emergency braking action greatly diminishes the risk of injury in the event of a collision of the motor vehicle 10 with a road user. Furthermore, the risk that the unprotected road user is run over by the motor vehicle 10 after collision with the motor vehicle is also reduced.

Slowing down the travel speed of the motor vehicle 10 through activation of the service brake 20 generally lowers also the danger of a secondary collision of the motor vehicle with a road user other than the unprotected road user that was hit first. This also reduces the risk of injury for vehicle occupants of the motor vehicle 10.

When the motor vehicle 10 travels in an urban environment, a travel speed of for example about 40 km/h can be decreased when the control device 14 activates the service brake 20. At the reduced travel speed of the motor vehicle 10, the severity of a possible secondary collision with other road users is much less. The motor vehicle 10 can be brought to a complete halt by the autonomous emergency braking via the service brake 20 depending on the travel speed.

The control device 14 can be configured to trigger deployment of the protection device, e.g. window airbag 18, as a function of an algorithm and to transmit a signal to a controller of the service brake 20 in dependence on the decision to trigger the protection device 18 so as to command engagement of the service brake 20. The decision to trigger the protection device 18 may also be used to deploy the protection device 18 and to activate the autonomous emergency braking. In other words, the control device 14 generates a signal that contains both control commands, i.e. deployment of the protection device 18, e.g. window air bag through ignition of a gas generator of the window airbag, and activation of the service brake 20.

In particular, when the sensor 12 or a further sensor are configured to monitor the surroundings ahead of the motor vehicle 10, as viewed in travel direction 16, the service brake 20 may be preconditioned in the event of an imminent collision, for example by increasing a brake pressure. As a result, the service brake 20 reacts faster to a signal transmitted by the control device 14 in order to initiate the emergency braking action.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A method of operating a motor vehicle; comprising:
transmitting a trigger signal to at least one protection device for protecting a pedestrian in the event of an impending collision with the motor vehicle so as to activate the protection device and cause the protection device to assume a functional position ready for protection; and
activating a brake device in response to a transmission of the trigger signal.

2. The method of claim 1, wherein the activating step includes a braking of the motor vehicle over a predefined time interval.

3. The method of claim 1, wherein the activating step includes a braking of the motor vehicle with a predefined negative acceleration.

4. The method of claim 1, wherein the activating step includes a braking of the motor vehicle to decrease a travel speed by a predefined magnitude, or a braking of the motor vehicle to a predefined travel speed.

5. The method of claim 4, wherein the predefined magnitude ranges from 15 km/h to 35 km/h.

6. The method of claim 4, wherein the predefined travel speed is less than 40 km/h, preferably 20 km/h.

7. The method of claim 1, wherein the activating step includes a braking of the motor vehicle to a point in time in which a driver of the motor vehicle becomes proactive by engaging the brake device or operating a steering wheel.

8. The method of claim 1, wherein the activating step includes a deceleration of the motor vehicle to a standstill.

9. The method of claim 1, wherein the activating step includes transmitting a signal from a sensor which is rendered operational when an object behind the motor vehicle is detected in travel direction.

10. The method of claim 1, wherein the activating step includes increasing a pressure of a pressure fluid of the brake device when at least one sensor detects an object in a trajectory of the motor vehicle.

11. The method of claim 1, wherein the at least one protection device is an outside airbag, said transmitting step including sending the trigger signal to a controller of the outside airbag of the motor vehicle.

12. A motor vehicle, comprising:
at least one protection device for protecting a pedestrian in the event of an impending collision with the motor vehicle, said at least one protection device being constructed to assume a functional position ready for protection when activated in response to a trigger signal;
a brake device; and
a control device constructed to operate the brake device in response to a transmission of the trigger signal to the at least one protection device.

13. The motor vehicle of claim 12, wherein the brake device is operative over a predefined time interval.

14. The motor vehicle of claim 12, wherein the brake device is operative to effect a predefined negative acceleration.

15. The motor vehicle of claim 12, wherein the brake device is operative to decrease a travel speed by a predefined magnitude or to slow down the motor vehicle to a predefined travel speed.

16. The motor vehicle of claim 12, wherein the control device is constructed to operate the brake device until a driver of the motor vehicle becomes proactive by engaging the brake device or operating a steering wheel.

17. The motor vehicle of claim 12, wherein the brake device is operative until the motor vehicle comes to a standstill.

18. The motor vehicle of claim 12, further comprising a sensor to detect an object behind the motor vehicle, as viewed in travel direction, said brake device being activated when a signal from the sensor is transmitted to the control device.

19. The motor vehicle of claim 12, further comprising a sensor to detect an object in a trajectory of the motor vehicle, said brake device being constructed to increase a pressure of a pressure fluid of the brake device when a signal from the sensor is transmitted to the control device.

20. The motor vehicle of claim 12, wherein the at least one protection device is an outside airbag having a controller which is operably connected to the control device, said outside airbag being deployed in response to the trigger signal sent from the control device to the controller of the outside airbag.
